(19) United States
(12) Patent Application Publication
(10) Pub. No.: US 2009/0233684 A1
(43) Pub. Date: Sep. 17, 2009

(54) METHOD OF GAMING, A GAME CONTROLLER AND A GAMING SYSTEM

(75) Inventor: Michael A. Shai-Hee, Kingsgrove (AU)

Correspondence Address: HANLEY, FLIGHT & ZIMMERMAN, LLC, 150 S. WACKER DRIVE, SUITE 2100, CHICAGO, IL, 60606, US

(73) Assignee: Aristocrat Technologies Australia Pty Limited, Lane Cove (AU)

(21) Appl. No.: 12/333,065

(22) Filed: Dec. 11, 2008

(30) Foreign Application Priority Data
Dec. 14, 2007 (AU) 2007906825

(51) Int. Cl. A63F 9/24; A63F 13/00

(52) U.S. Cl. 463/20; 463/30

(57) ABSTRACT

A method of gaming comprising: selecting a plurality of symbols from a set of symbols for display at a plurality of display positions; displaying a modifying symbol as moving relative to a plurality of the display positions; determining a stop display position at which the modifying symbol is to stop; modifying the displayed symbol at the stop display position with the modifying symbol; and determining whether the displayed symbols at the display positions after modification by the modifying symbol correspond to a win outcome.

### CROSS-REFERENCE TO RELATED APPLICATIONS

The present application claims the benefit of priority to Australian Provisional Patent Application No. 2007906825, filed on Dec. 14, 2007, entitled “A METHOD OF GAMING, A GAME CONTROLLER AND A GAMING SYSTEM”, which is herein incorporated by reference in its entirety.

### FIELD

The present invention relates to a method of gaming, a gaming controller and a gaming system.

### BACKGROUND OF THE INVENTION

Many gaming machines provide games where a plurality of reels are spun and it is determined whether a player has won based on the symbols displayed on the display after the reels have spun to a stop. While such games provide enjoyment, there is a continuing need to add additional features to such games to further improve player enjoyment.

### SUMMARY OF THE INVENTION

In a first aspect, the invention provides a method of gaming including:
selecting a plurality of symbols from a set of symbols for display at a plurality of display positions;
displaying a modifying symbol as moving relative to a plurality of the display positions;
determining a stop display position at which the modifying symbol is to stop;
modifying the displayed symbol at the stop display position with the modifying symbol; and
determining whether the displayed symbols at the display positions after modification by the modifying symbol correspond to a win outcome.

In an embodiment, modifying the displayed symbol at the stop display position includes replacing the displayed symbol with the modifying symbol.

In an embodiment, modifying the displayed symbol at the stop display position includes adding the modifying symbol to the displayed symbol.

In an embodiment, the modifying symbol is displayed as moving at least partly after all the other symbols are displayed in their display positions.

In an embodiment, subsets of the display positions correspond to respective ones of a plurality of reels.

In an embodiment, determining whether there is a winning outcome involves evaluating the displayed symbols based on a player win entitlement.

In an embodiment, the player win entitlement is determined based on a player selection of play lines.

In an embodiment, the player win entitlement is determined based on a player selection of reels.

In an embodiment, the player win entitlement is determined based on a player selection of pay tables.

In an embodiment, the modifying symbol is displayed as moving along a designated path.

In an embodiment, the designated symbol is displayed as moving forward and back along the path.

In an embodiment, the path is vertical.

In an embodiment, the path is horizontal.

In an embodiment, the path is diagonal.

In an embodiment, the modifying symbol is displayed as moving relative to an anchor point.

In an embodiment, the modifying symbol is displayed as moving as if anchored to the anchor point by an elastic member.

In an embodiment, the method further includes determining whether the displayed symbols at the display positions before modification by the modifying symbol correspond to a win outcome.

In an embodiment, the symbol is displayed as moving at a constant speed.

In an embodiment, the symbol is displayed as moving at a random speed.

In an embodiment, the modifying symbol is a wild symbol.

In an embodiment, at least some of the displayed symbols are selected randomly.

In an embodiment, the method includes selecting the stop position of the moving symbol randomly.

In an embodiment, the modifying symbol traverses the plurality of symbols repeatedly.

In a second aspect, the invention provides a game controller arranged to:
select a plurality of symbols from a set of symbols for display at a plurality of display positions on a display;
cause the display to display a modifying symbol as moving relative to a plurality of the display positions;
determine a stop display position at which the modifying symbol is to stop;
modify the displayed symbol at the stop display position with the modifying symbol; and
determine whether the displayed symbols at the display positions after modification by the modifying symbol correspond to a win outcome.

In an embodiment, the game controller includes a modifying symbol stop selector arranged to select the stopping position of the modifying symbol.

In an embodiment, the game controller is arranged to modify the displayed symbol at the stop display position by replacing the displayed symbol with the modifying symbol.

In an embodiment, the game controller is arranged to modify the displayed symbol at the stop display position by adding the modifying symbol to the displayed symbol.

In an embodiment, the game controller is arranged to display the modifying symbol as moving at least partly after all the other symbols are displayed in their display positions.

In an embodiment, subsets of the display positions correspond to respective ones of a plurality of reels.

In an embodiment, the game controller is arranged to determine whether there is a winning outcome by evaluating the displayed symbols based on a player win entitlement.

In an embodiment, the game controller is arranged to display the modifying symbol as moving along a designated path.

In an embodiment, the game controller is arranged to display the modifying symbol as moving forward and back along the path.

In an embodiment, the path is vertical, horizontal or diagonal.

In an embodiment, the game controller is arranged to display the modifying symbol as moving relative to an anchor point.

In an embodiment, the game controller is arranged to display the modifying symbol as moving as if anchored to the anchor point by an elastic member.

In an embodiment, the modifying symbol traverses the plurality of symbols repeatedly.

In an embodiment, the game controller is further arranged to determine whether the displayed symbols at the display positions before modification by the modifying symbol correspond to a win outcome.

In an embodiment, the symbol is displayed as moving at a constant speed or a random speed.

In an embodiment, the modifying symbol is a wild symbol.

In an embodiment, the game controller is arranged to randomly select the stop position of the moving symbol.

In an embodiment, the game controller is implemented by a processor executing program code stored in a memory.

In a third aspect, the invention provides a gaming system including:
a display; and
a game controller arranged to:
select a plurality of symbols from a set of symbols for display at a plurality of display positions on the display;
cause the display to display a modifying symbol as moving relative to a plurality of the display positions;
determine a stop display position at which the modifying symbol is to stop;
modify the displayed symbol at the stop display position with the modifying symbol; and
determine whether the displayed symbols at the display positions after modification by the modifying symbol correspond to a win outcome.

In an embodiment, the game controller includes a modifying symbol stop selector arranged to select the stopping position of the modifying symbol.

In an embodiment, the game controller is arranged to modify the displayed symbol at the stop display position by replacing the displayed symbol with the modifying symbol.

In an embodiment, the game controller is arranged to modify the displayed symbol at the stop display position by adding the modifying symbol to the displayed symbol.

In an embodiment, the game controller is arranged to display the modifying symbol as moving at least partly after all the other symbols are displayed in their display positions.

In an embodiment, subsets of the display positions correspond to respective ones of a plurality of reels.

In an embodiment, the game controller is arranged to determine whether there is a winning outcome by evaluating the displayed symbols based on a player win entitlement.

In an embodiment, the game controller is arranged to display the modifying symbol as moving along a designated path.

In an embodiment, the game controller is arranged to display the modifying symbol as moving forward and back along the path.

In an embodiment, the path is vertical, horizontal or diagonal.

In an embodiment, the game controller is arranged to display the modifying symbol as moving relative to an anchor point.

In an embodiment, the game controller is arranged to display the modifying symbol as moving as if anchored to the anchor point by an elastic member.

In an embodiment, the modifying symbol traverses the plurality of symbols repeatedly.

In an embodiment, the game controller is further arranged to determine whether the displayed symbols at the display positions before modification by the modifying symbol correspond to a win outcome.

In an embodiment, the symbol is displayed as moving at a constant speed or a random speed.

In an embodiment, the modifying symbol is a wild symbol.

In an embodiment, the game controller is arranged to randomly select the stop position of the moving symbol.

In an embodiment, the gaming system includes a processor executing program code stored in a memory to implement the game controller.

In an embodiment, the gaming system includes a game play mechanism operable by a player to initiate a play of the game.

In a fourth aspect, the invention provides computer program code which when executed implements the above method.

In a fifth aspect, the invention provides computer readable medium including the above computer program code.

In a sixth aspect, the invention provides a data signal including the above computer program code.

In a seventh aspect, the invention extends to transmitting the above computer program code.

### BRIEF DESCRIPTION OF DRAWINGS

FIG. 1 is a block diagram of the core components of a gaming system.

FIG. 2 is a perspective view of a stand alone gaming machine;

FIG. 3 is a block diagram of the functional components of a gaming machine;

FIG. 4 is a schematic diagram of the functional components of a memory;

FIG. 5 is a schematic diagram of a network gaming system;

FIG. 6 is a block diagram of further components of a gaming system of an embodiment;

FIG. 7 is a flow chart of an embodiment; and

FIG. 8 is an exemplary display provided in accordance with the embodiment.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION

Referring to the drawings, there is shown a gaming system having a game controller arranged to implement a game where a symbols are selected for each of a plurality of display positions and a symbol moves over the display positions and stops at one of the display positions, modifying the symbol at that display position. In one example, it does this by “vibrating” relative to one position. The gaming system can take a number of different forms.

In a first form, a stand alone gaming machine is provided wherein all or most components for implementing the game are present in a player operable gaming machine.

In a second form, a distributed architecture is provided wherein some of the components for implementing the game are present in a player operable gaming machine and some of the components for implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

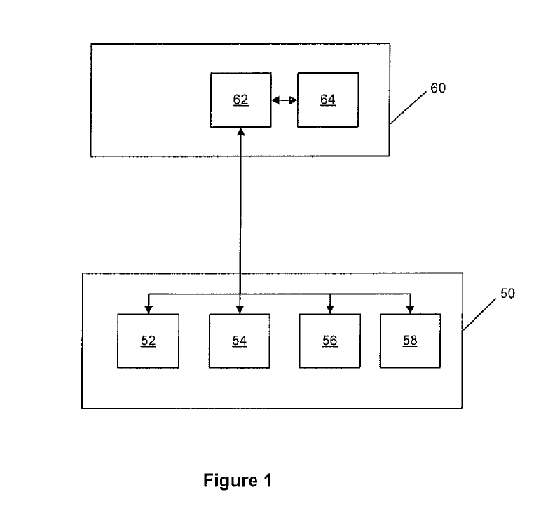

Irrespective of the form, the gaming system includes several core components. At the broadest level, the core components are a player interface 50 and a game controller 60 as illustrated in FIG. 1. The player interface is arranged to enable manual interaction between a player and the gaming system and for this purpose includes the input/output components for the player to enter instructions and play the game.

Components of the player interface may vary from embodiment to embodiment but will typically include a credit mechanism 52 to enable a player to input credits and receive payouts, one or more displays 54, a game play mechanism 56 that enables a player to input game play instructions (e.g. to place bets), and one or more speakers 58.

The game controller 60 is in data communication with the player interface and typically includes a processor 62 that processes the game play instructions in accordance with game play rules and outputs game play outcomes to the display. Typically, the game play instructions are stored as program code in a memory 64 but can also be hardwired. Herein the term “processor” is used to refer generically to any device that can process game play instructions in accordance with game play rules and may include: a microprocessor, microcontroller, programmable logic device or other computational device, a general purpose computer (e.g. a PC) or a server.

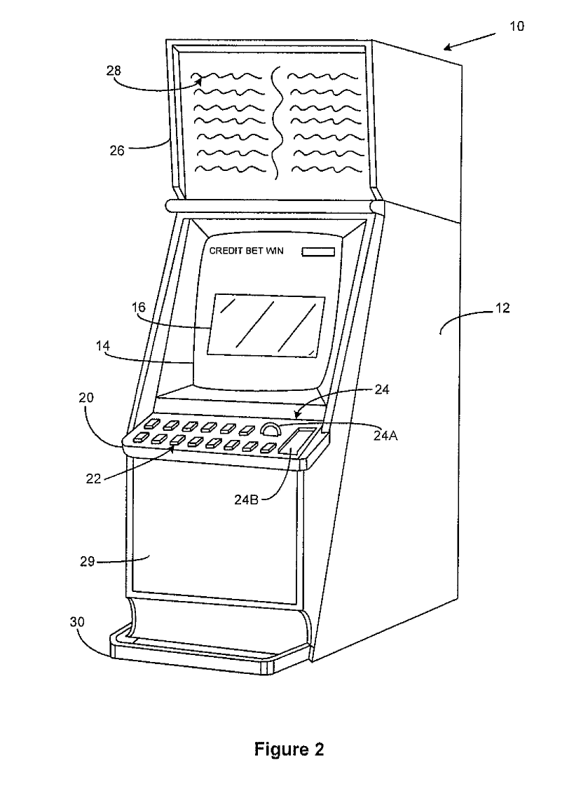

A gaming system in the form of a stand alone gaming machine 10 is illustrated in FIG. 2. The gaming machine 10 includes a console 12 having a display 14 on which are displayed representations of a game 16 that can be played by a player. A mid-trim 20 of the gaming machine 10 houses a bank of buttons 22 for enabling a player to interact with the gaming machine, in particular during game play. The mid-trim 20 also houses a credit input mechanism 24 which in this example includes a coin input chute 24A and a bill collector 24B. Other credit input mechanisms may also be employed, for example, a card reader for reading a smart card, debit card or credit card. A player marketing module (not shown) having a reading device may also be provided for the purpose of reading a player tracking device, for example as part of a loyalty program. The player tracking device may be in the form of a card, flash drive or any other portable storage medium capable of being read by the reading device.

A top box 26 may carry artwork 28, including for example pay tables and details of bonus awards and other information or images relating to the game. Further artwork and/or information may be provided on a front panel 29 of the console 12. A coin tray 30 is mounted beneath the front panel 29 for dispensing cash payouts from the gaming machine 10.

The display 14 shown in FIG. 2 is in the form of a video display unit, particularly a cathode ray tube screen device. Alternatively, the display 14 may be a liquid crystal display, plasma screen or any other suitable video display unit. The top box 26 may also include a display, for example a video display unit, which may be of the same type as the display 14, or of a different type.

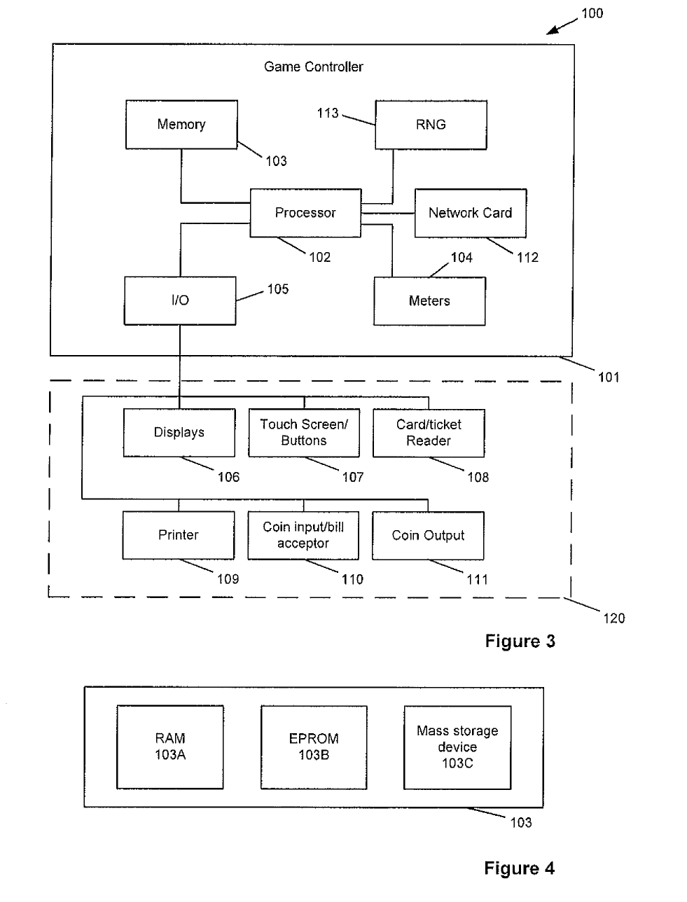

FIG. 3 shows a block diagram of operative components of a typical gaming machine which may be the same as or different to the gaming machine of FIG. 2.

The gaming machine 100 includes a game controller 101 having a processor 102. Instructions and data to control operation of the processor 102 are stored in a memory 103, which is in data communication with the processor 102. Typically, the gaming machine 100 will include both volatile and non-volatile memory and more than one of each type of memory, with such memories being collectively represented by the memory 103.

The gaming machine has hardware meters 104 for purposes including ensuring regulatory compliance and monitoring player credit, an input/output (I/O) interface 105 for communicating with peripheral devices of the gaming machine 100. The input/output interface 105 and/or the peripheral devices may be intelligent devices with their own memory for storing associated instructions and data for use with the input/output interface or the peripheral devices. A random number generator module 113 generates random numbers for use by the processor 102. Persons skilled in the art will appreciate that the reference to random numbers includes pseudo-random numbers.

In the example shown in FIG. 3, a player interface 120 includes peripheral devices that communicate with the game controller 101 include one or more displays 106, a touch screen and/or buttons 107, a card and/or ticket reader 108, a printer 109, a bill acceptor and/or coin input mechanism 110 and a coin output mechanism 111. Additional hardware may be included as part of the gaming machine 100, or hardware may be omitted based on the specific implementation.

In addition, the gaming machine 100 may include a communications interface, for example a network card 112. The network card may, for example, send status information, accounting information or other information to a central controller, server or database and receive data or commands from the central controller, server or database.

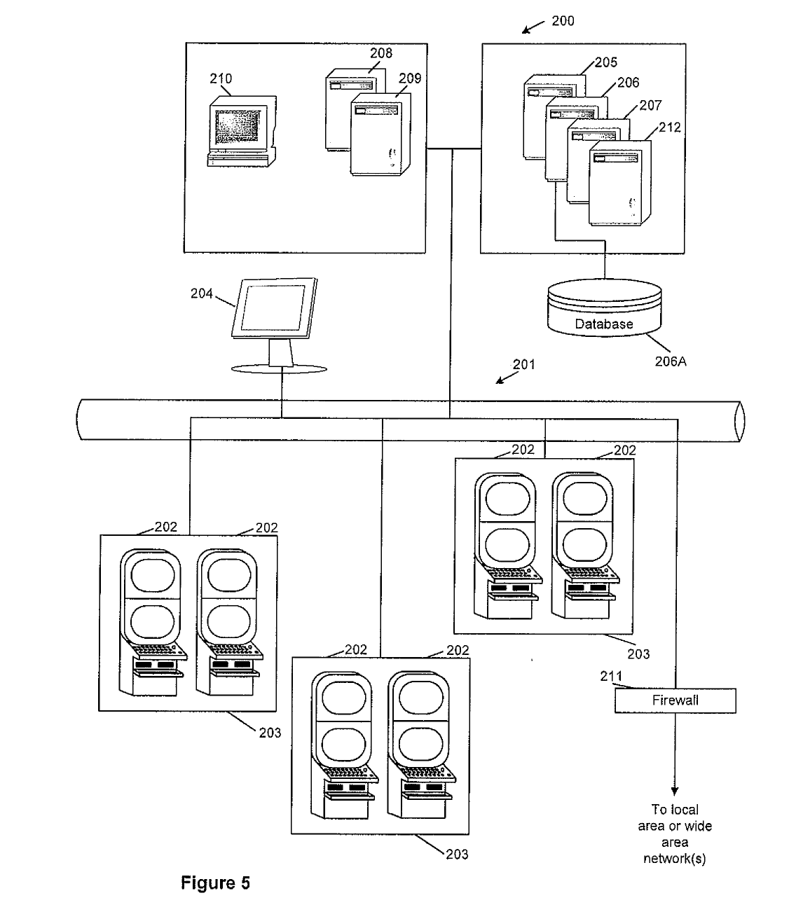

FIG. 4 shows a block diagram of the main components of an exemplary memory 103. The memory 103 may include RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

It is also possible for the operative components of the gaming machine 100 to be distributed, for example input/output devices 106, 107, 108, 109, 110, 111 to be provided remotely from the game controller 101.

FIG. 5 shows a gaming system 200 in accordance with an alternative embodiment. The gaming system 200 includes a network 201, which for example may be an Ethernet network. Gaming machines 202, shown arranged in three banks 203 of two gaming machines 202 in FIG. 5, are connected to the network 201. The gaming machines 202 provide a player operable interface and may be the same as the gaming machines 10, 100 shown in FIGS. 2 and 3 respectively, or may have simplified functionality depending on the requirements for implementing game play. While banks 203 of two gaming machines are illustrated in FIG. 5, banks of one, three or more gaming machines are also envisaged.

One or more displays 204 may also be connected to the network 201. For example, the displays 204 may be associated with one or more banks 203 of gaming machines. The displays 204 may be used to display representations associated with game play on the gaming machines 202, and/or used to display other representations, for example promotional or informational material.

In a thick client embodiment, game server 205 implements part of the game played by a player using a gaming machine 202 and the gaming machine 202 implements part of the game. With this embodiment, as both the game server and the gaming device implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to perform accounting functions for the Jackpot game. A loyalty program server 212 may also be provided.

In a thin client embodiment, game server 205 implements most or all of the game played by a player using a gaming machine 202 and the gaming machine 202 essentially provides only the player interface. With this embodiment, the game server 205 provides the game controller. The gaming machine will receive player instructions, pass these to the game server which will process them and return game play outcomes to the gaming machine for display. In a thin client embodiment, the gaming machines could be computer terminals, e.g. PCs running software that provides a player interface operable using standard computer input and output components.

Servers are also typically provided to assist in the administration of the gaming network 200, including for example a gaming floor management server 208, and a licensing server 209 to monitor the use of licenses relating to particular games. An administrator terminal 210 is provided to allow an administrator to run the network 201 and the devices connected to the network.

The gaming system 200 may communicate with other gaming systems, other local networks, for example a corporate network, and/or a wide area network such as the Internet, for example through a firewall 211.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random generator engine. Alternatively, a separate random number generator server could be provided. Further, persons skilled in the art will appreciate that a plurality of game servers could be provided to run different games or a single game server may run a plurality of different games based on the terminals.

### Further Detail of Gaming System

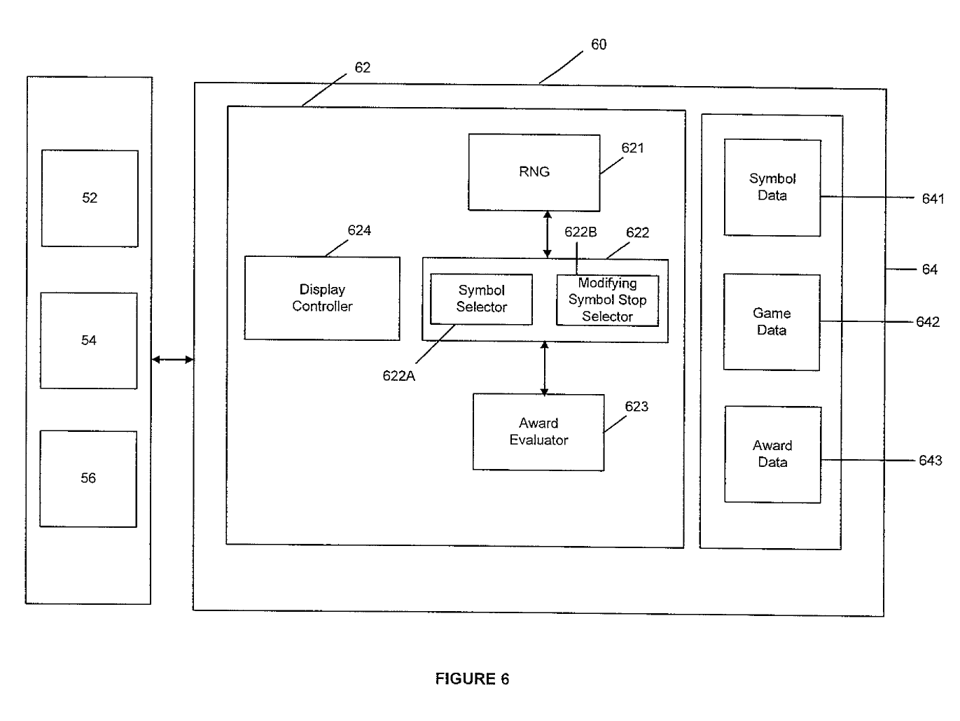

The gaming system of the embodiment is shown in more detail in FIG. 6. It will be seen in FIG. 6, that the processor 62 of game controller 60 implements a series of modules based on game program code 642 stored in memory 64. Persons skilled in the art will appreciate that not all modules need be implemented by processor 62. For example, some of the modules could be implemented by dedicated hardware.

To begin the game, a player makes one or more player selections by operating the game play mechanism 56 (e.g. by pressing buttons corresponding to the selection). The embodiment can be used with known player selections. Such selections typically include a bet amount to purchase a win entitlement. However, some games may be free and hence not require a bet selection. The embodiment is implemented in relation to a spinning reel type game.

In such games, the player is also required to make a selection which affects the player's entitlement to winning outcomes. A number of techniques for making a selection are compatible with the embodiment. For example, the player may select how many play lines to play. In such an example, after the reels have been spun, the determination as to whether there is a winning outcome is made, at least partly, on the basis of the play lines the player selected. In such games, the player's win entitlement may extend beyond the play lines the player selected to include other types of pays—for example, so-called scatter pays which operate independently of player selected play lines. Other examples of a player selection include selecting reels (in effect a selection of all symbols on the reel to substitute at one or more display positions) and selecting symbols to play (e.g. to obtain access to pay tables involving those symbols).

When the player's selection is completed, the symbol selector 622A of the outcome generator 622 selects a plurality of symbols from symbol data 641 for display at a plurality of display positions on the display 54. In the embodiment, the symbol data 641 specifies a number of reels in a symbol sequence. For example for each reel, there may be 20 symbols S1, S2, . . . S20. The symbol selector 622A employs a random number generator 621 to determine a stop position, being a place in the sequence. This reel is then controlled to stop at a position on the display corresponding to the stop position. For example, if three symbols of each reel are to be displayed in display positions, the symbol corresponding to the selected place in the sequence may be displayed a middle position and the symbols before and after it in the sequence will be displayed below and above it. Display of the symbols spinning to the selected stopping positions for each reel is performed under control of the display controller 624 which can employ an appropriate graphics driver for display 54.

In the embodiment, the outcome generator 622 also includes a modifying symbol stop selector 622B. In the embodiment the modifying symbol is displayed by display controller 624 as moving relative to the display positions such that it moves over a plurality of display positions. In an embodiment, the modifying symbol follows a designated path or pattern such that the symbols on which it may stop are apparent to the player. In an embodiment, the modifying symbol traverses the path repeatedly before the modifying symbol stops. The modifying symbol stop selector 622B employs the random number generator to select a display position at which the modifying symbol is to be stopped. Display controller 624 then controls the display to show the modifying symbol stopping at the selected display position and modifying the existing symbol at that position, for example by replacing it or forming a combined symbol from the modifying symbol and the existing symbol.

The award evaluator 623 then evaluates whether to make an award based on award data 643 (e.g. pay tables) and the player's win entitlement. In one embodiment, the award evaluator makes a first evaluation based on the symbols in the display positions before the modification and a subsequent evaluation (as described above) after the modification.

Persons skilled in the art will appreciate that the symbol may be displayed as moving in a number of different ways. As indicated above, it is that the symbol move relative to a set of display positions—i.e. on a path. This can be achieved, for example, by showing the symbol moving up and down a reel column or across a row. Other movements, for example, diagonal or circular movements are also possible. In a particular embodiment, the movement is shown as relative to an anchor or tether point or points. For example, as if the modifying symbol is attached to it by something elastic such as a spring or elastic band. In the embodiment, the anchor or tether point is the centre of a column or the middle of a row of display positions such that the symbol “vibrates” relative to the tether point.

In the embodiment, the moving symbol is a wild symbol which when it stops replaces the symbol at that position such that there is a wild symbol that display position, thus, allowing further opportunities of winning. In other embodiments, the modifying symbol could be for example, a high value picture symbol which is involved in a large win. In this example, the symbol could also modify the display position at which it stops by being added to the existing symbol, for example, to form a composite symbol as is known in the art. In such an example, wins are evaluated based on both the symbols which occupy the display position at which the modifying symbol stops.

Persons skilled in the art will appreciate that the modifying symbol can be displayed in a number of different ways including as being held by springs attached to a frame above and below the display position such that the object is pushed up of pulled down by the springs and then released.

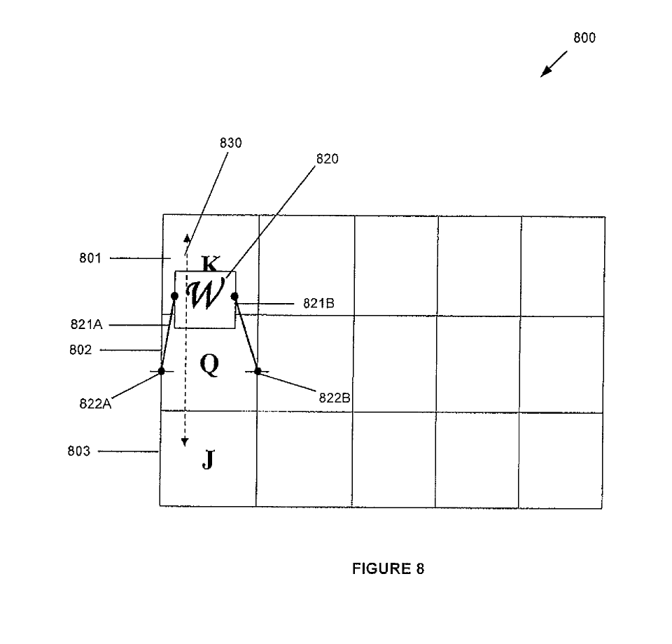

FIG. 8 shows one exemplary display 800 corresponding to a five reel, three display positions per reel arrangement resulting in fifteen display positions. The modifying symbol 820 is arranged to move over three symbol positions 801, 802 and 803. The wild symbol is displayed as being attached via elastic bands 821a, 821b to tether points 822a and 822b respectively such that it moves back and forth as indicated by arrow 830.

In the embodiment, the modifying symbol stop selector 622b is arranged to give even chances of the modifying symbols stopping at any of the display positions over which the modifying symbol moves. However, persons skilled in the art will appreciate that the selection of particular stop positions can be biased towards one or more of the stop positions relative to other stop positions.

The time at which the modifying symbol appears can be varied. In one embodiment, the modifying symbol moves while the reels are spinning. In another embodiment, the modifying symbol only appears after the reels stop.

In some embodiments, the modifying symbol will appear in each game. In other embodiments, the modifying symbol will only appear when the player establishes an entitlement. The entitlement may be established by placing an additional bet, by a symbol combination appearing on the reels, in response to turnover or in accordance with other techniques known in the art.

In other embodiments, even when the player has the entitlement, for example, by placing an additional bet, display of the modifying symbol may not occur until a condition has been met for example, a particular symbol combination or other trigger event has occurred.

Persons skilled in the art will appreciate that the invention is not limited to trigger events that occur on the gaming machine and include trigger events, for example, communicated to the gaming machine from a connected system.

Other variations will be apparent to a person skilled in the art. For example, the speed of movement can be varied or constant. Further it will be apparent that features of carious embodiments can be combined to form further embodiments.

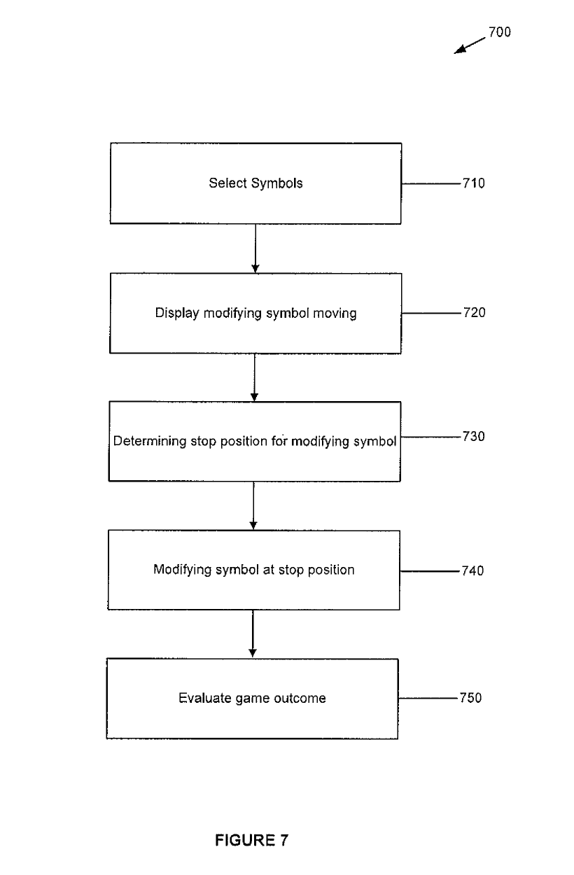

The method 700 is summarised in FIG. 7. Method 700 involves selecting symbols 710, displaying the modifying symbol as moving 720 relative to the display, determining the stop position for modifying symbol 730, modifying the symbol at the determined stop position 740 and evaluating the game outcome 750.

Further aspects of the method will be apparent from the above description of the gaming system. Persons skilled in the art will also appreciate that the method could be embodied in program code. The program code could be supplied in a number of ways, for example on a computer readable medium, such as a disc or a memory (for example, that could replace part of memory 103) or as a data signal (for example, by downloading it from a server).

In the claims which follow and in the preceding description of the invention, except where the context indicates otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art, in Australia or any other country.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive. Several embodiments are described above with reference to the drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any electronic device and/or machine-readable media suitable for accomplishing its operations. Certain embodiments of the present invention may be implemented using an existing computer processor and/or by a special purpose computer processor incorporated for this or another purpose or by a hardwired system, for example.

Embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

1. A method of gaming comprising:
selecting a plurality of symbols from a set of symbols for display at a plurality of display positions;
displaying a modifying symbol as moving relative to a plurality of the display positions;
determining a stop display position at which the modifying symbol is to stop;
modifying the displayed symbol at the stop display position with the modifying symbol; and
determining whether the displayed symbols at the display positions after modification by the modifying symbol correspond to a win outcome.

2. A method as claimed in claim 1, wherein modifying the displayed symbol at the stop display position comprises replacing the displayed symbol with the modifying symbol.

3. A method as claimed in claim 1, wherein modifying the displayed symbol at the stop display position comprises adding the modifying symbol to the displayed symbol.

4. A method as claimed in claim 1, wherein the modifying symbol is displayed as moving at least partly after all the other symbols are displayed in their display positions.

5. A method as claimed in claim 1, wherein subsets of the display positions correspond to respective ones of a plurality of reels.

6. A method as claimed in claim 1, wherein determining whether there is a winning outcome involves evaluating the displayed symbols based on a player win entitlement.

7. A method as claimed in claim 1, wherein the modifying symbol is displayed as moving along a designated path.

8. A method as claimed in claim 7, wherein the designated symbol is displayed as moving forward and back along the path.

9. A method as claimed in claim 7, wherein the path is vertical, horizontal or diagonal.

10. A method as claimed in claim 1, wherein the modifying symbol is displayed as moving relative to an anchor point.

11. A method as claimed in claim 10, wherein the modifying symbol is displayed as moving as if anchored to the anchor point by an elastic member.

12. A method as claimed in claim 10 wherein the modifying symbol traverses the plurality of symbols repeatedly.

13. A method as claimed in claim 1, further comprising determining whether the displayed symbols at the display positions before modification by the modifying symbol correspond to a win outcome.

14. A method as claimed in claim 1, wherein the symbol is displayed as moving at a constant speed or a random speed.

15. A method as claimed in claim 1, wherein the modifying symbol is a wild symbol.

16. A method as claimed in claim 1, comprising selecting the stop position of the moving symbol randomly.

17. A game controller for a gaming system, the game controller arranged to:
select a plurality of symbols from a set of symbols for display at a plurality of display positions on a display;
cause the display to display a modifying symbol as moving relative to a plurality of the display positions;
determine a stop display position at which the modifying symbol is to stop;
modify the displayed symbol at the stop display position with the modifying symbol; and
determine whether the displayed symbols at the display positions after modification by the modifying symbol correspond to a win outcome.

18. A game controller as claimed in claim 17, comprising a modifying symbol stop selector arranged to select the stopping position of the modifying symbol.

19. A game controller as claimed in claim 17, arranged to modify the displayed symbol at the stop display position by replacing the displayed symbol with the modifying symbol.

20. A game controller as claimed in claim 17, arranged to modify the displayed symbol at the stop display position by adding the modifying symbol to the displayed symbol.

21. A game controller as claimed in claim 17, arranged to display the modifying symbol as moving at least partly after all the other symbols are displayed in their display positions.

22. A game controller as claimed in claim 17, wherein subsets of the display positions correspond to respective ones of a plurality of reels.

23. A game controller as claimed in claim 17, arranged to determine whether there is a winning outcome by evaluating the displayed symbols based on a player win entitlement.

24. A game controller as claimed in claim 17, arranged to display the modifying symbol as moving along a designated path.

25. A game controller as claimed in claim 24, arranged to display the modifying symbol as moving forward and back along the path.

26. A game controller as claimed in claim 24, wherein the path is vertical, horizontal or diagonal.

27. A game controller as claimed in claim 17, arranged to display the modifying symbol as moving relative to an anchor point.

28. A game controller as claimed in claim 27, arranged to display the modifying symbol as moving as if anchored to the anchor point by an elastic member.

29. A game controller as claimed in claim 27, wherein the modifying symbol traverses the plurality of symbols repeatedly.

30. A game controller as claimed in claim 17, further arranged to determine whether the displayed symbols at the display positions before modification by the modifying symbol correspond to a win outcome.

31. A game controller as claimed in claim 17, wherein the symbol is displayed as moving at a constant speed or a random speed.

32. A game controller as claimed in claim 17, wherein the modifying symbol is a wild symbol.

33. A game controller as claimed in claim 17, arranged to randomly select the stop position of the moving symbol.

34. A game controller as claimed in claim 17, implemented by a processor executing program code stored in a memory.

35. A gaming system comprising:
a display; and
a game controller arranged to:
select a plurality of symbols from a set of symbols for display at a plurality of display positions on the display;
cause the display to display a modifying symbol as moving relative to a plurality of the display positions;
determine a stop display position at which the modifying symbol is to stop;
modify the displayed symbol at the stop display position with the modifying symbol; and
determine whether the displayed symbols at the display positions after modification by the modifying symbol correspond to a win outcome.

36. A gaming system as claimed in claim 35, wherein the game controller comprises a modifying symbol stop selector arranged to select the stopping position of the modifying symbol.

37. A gaming system as claimed in claim 35, wherein the game controller is arranged to modify the displayed symbol at the stop display position by replacing the displayed symbol with the modifying symbol.

38. A gaming system as claimed in claim 35, wherein the game controller is arranged to modify the displayed symbol at the stop display position by adding the modifying symbol to the displayed symbol.

39. A gaming system as claimed in claim 35, wherein the game controller is arranged to display the modifying symbol as moving at least partly after all the other symbols are displayed in their display positions.

40. A gaming system as claimed in claim 35, wherein subsets of the display positions correspond to respective ones of a plurality of reels.

41. A gaming system as claimed in claim 35, wherein the game controller is arranged to determine whether there is a winning outcome by evaluating the displayed symbols based on a player win entitlement.

42. A gaming system as claimed in claim 35, wherein the game controller is arranged to display the modifying symbol as moving along a designated path.

43. A gaming system as claimed in claim 42, wherein the game controller is arranged to display the modifying symbol as moving forward and back along the path.

44. A gaming system as claimed in claim 42, wherein the path is vertical, horizontal or diagonal.

45. A gaming system as claimed in claim 35, wherein the game controller is arranged to display the modifying symbol as moving relative to an anchor point.

46. A game controller as claimed in claim 45, wherein the game controller is arranged to display the modifying symbol as moving as if anchored to the anchor point by an elastic member.

47. A gaming system as claimed in claim 45, wherein the modifying symbol traverses the plurality of symbols repeatedly.

48. A gaming system as claimed in claim 35, wherein the game controller is further arranged to determine whether the displayed symbols at the display positions before modification by the modifying symbol correspond to a win outcome.

49. A gaming system as claimed in claim 35, wherein the symbol is displayed as moving at a constant speed or a random speed.

50. A gaming system as claimed in claim 35, wherein the modifying symbol is a wild symbol.

51. A gaming system as claimed in claim 35, a wherein the game controller is arranged to randomly select the stop position of the moving symbol.

52. A gaming system as claimed in claim 35, comprising a processor executing program code stored in a memory to implement the game controller.

53. A gaming system as claimed in claim 35, comprising a game play mechanism operable by a player to initiate a play of the game.

54. A computer readable medium including computer program code which when executed implements a method of gaming, the method comprising:
selecting a plurality of symbols from a set of symbols for display at a plurality of display positions;
displaying a modifying symbol as moving relative to a plurality of the display positions;
determining a stop display position at which the modifying symbol is to stop;
modifying the displayed symbol at the stop display position with the modifying symbol; and
determining whether the displayed symbols at the display positions after modification by the modifying symbol correspond to a win outcome.
